(19) United States
(12) Patent Application Publication
(10) Pub. No.: US 2010/0036056 A1
(43) Pub. Date: Feb. 11, 2010

(54) RADICAL COLD CURING OF SYNTHETIC RESINS BASED ON MODIFIED POLY(METH) ACRYLATES COMPRISING REACTIVE ETHYLENIC GROUPS

(75) Inventors: Peter Kuhlmann, Wulfrath (DE); Andreas Lehrschmacher, Dusseldorf (DE); Klaus Houck, Regen (DE)

Correspondence Address: RATNERPRESTIA, P.O. BOX 980, VALLEY FORGE, PA, 19482, US

(73) Assignee: ASHLAND-SÜDCHEMIE KERNFEST GMBH, WÜLFRATH (DE)

(21) Appl. No.: 12/444,456

(22) PCT Filed: Oct. 5, 2007
(86) PCT No.: PCT/EP07/08665

§ 371 Date: Oct. 13, 2009

(30) Foreign Application Priority Data
Oct. 9, 2006 (DE) 10 2006 047 687.5
Mar. 23, 2007 (DE) 10 2007 014 122.1

(51) Int. Cl. C08F 8/30

(52) U.S. Cl. 525/126

(57) ABSTRACT

The present invention relates to the radical cold curing of synthetic resins based on poly(meth)acrylate-urethane(meth)acrylates in urethane(meth)acrylates and optionally (meth)acrylates and/or reactive diluents using suitable additives, and also the use of these radically cold-curable synthetic resins as binding agents in radically cold-curable mixtures, as well as the organic synthetic glasses/plastics, synthetic glass/plastic workpieces and composite materials and workpieces obtained from these mixtures by radical cold curing, and also the production and use of these same mixtures, organic synthetic glasses/plastics, synthetic glass/plastic workpieces and composite materials and workpieces.

This is a U.S. National Phase Application of PCT International Application No. PCT/EP2007/008665, filed Oct. 5, 2007 (incorporated by reference herein in its entirety), and claims priority of DE 10 2007 014122.1, filed Mar. 23, 2007 and DE 10 2006 047 687.5 filed Oct. 9, 2006.

### FIELD OF THE INVENTION

The present invention relates to the radical cold curing of synthetic resins based on poly(meth)acrylate-urethane(meth)acrylates in urethane(meth)acrylates and optionally (meth)acrylates and/or reactive diluents using suitable additives, and also the use of these radically cold-curable synthetic resins as binding agents in radically cold-curable mixtures, as well as the organic synthetic glasses/plastics, synthetic glass/plastic workpieces and composite materials and workpieces obtained from these mixtures by radical cold curing, and also the production and use of these same mixtures, organic synthetic glasses/plastics, synthetic glass/plastic workpieces and composite materials and workpieces.

The cold curing is characterized in particular here by the fact that the presence of basic fillers in the mixture to be cured is not strictly necessary and at the same time the cured products obtained via them are light-fast, colourless and, depending on the combination of curing agents, additionally transparent.

### BACKGROUND OF THE INVENTION

Acrylic glasses are organic synthetic glasses made of polymethacrylates (polymerization products of methacrylic acid esters).

Plexiglas®, a hard, flexible, thermoplastic, glass-clear, colourless or tinted plastic made of polymethyl methacrylate (PMMA), is the best-known acrylic glass with a translucency of up to 93%, permeable to ultraviolet and X-rays.

It is deformable (at 140 to 160° C.), polishable, cuttable, grindable, weldable and can be turned, sawn, punched, filed, drilled and glued with polyacrylate and polymethacrylate adhesives.

The maximum service temperature is approximately 65 to 90° C. in the case of a long-lasting exposure and approximately 85 to 100° C. for a brief exposure.

It is resistant to water, lyes, dilute acids, gasoline, mineral oil, turpentine oil, but is swollen or dissolved for example by alcohols, esters, ketones, chlorinated hydrocarbons and benzene.

To clean Plexiglas®, water and rinsing agents, a soft cellulose sponge and a polishing and drying cloth are used, but not mineral powders (risk of scratching as Plexiglas® is more sensitive than glass), spot removers or the like (risk of disintegration).

Acrylic glass is produced by mass and bead polymerization and extrusion or injection moulding in the form of sheets, tubes, rods, blocks.

The oldest mass polymerization method is the chamber method for the production of Plexiglas® panels.

In this method, a prepolymer (viscous mixture of monomer and polymer material containing up to 25% PMMA) is poured, together with initiator (mostly peroxides such as benzoyl or lauryl peroxide, but also for example azoisobutyronitrile or the peroxosulphates/bisulphite combination) and optionally other additives, such as e.g. cross-linkers and comonomers, into a flat chamber comprising two silicate glass panes with a compressible sealing profile.

The use of prepolymerized material reduces shrinking, minimizes the generation of heat during the further polymerization and shortens the reaction time.

The radical polymerization then proceeds in the heating cabinet initially at 20-60° C. and is then completed at 100-130° C.

There is a volume shrinkage of up to 20% which is compensated by pressing the panels together, with the result that stresses are avoided. After the process, the polymethyl methacrylate panels can be easily separated from the glass panes.

There are many and varied possible uses of acrylic glass, thus it can be used, due to its excellent resistance to shattering and weathering, inter alia for safety glass panes, glazing in aircraft, buses and roofs, due to its excellent optical properties and good mechanical machinability, inter alia for lightweight magnifying lenses, prisms, lenses and optical fibres, due to its good UV resistance, inter alia in solaria, due to its good deformability, inter alia for watch-glasses or protective covering for machines and, due to its neutral smell and taste, inter alia for tubes in the drinks industry.

It also comes into consideration for sanitary components, such as bath tubs, shower trays and wash basins with a scratch-resistant silicone resin-based coating, as well as for example for sanitary fittings and containers in general, space lighting, instruments, corrugated panels in the construction trade, transparent sound-proof walls, items of office equipment, drawing requisites (set squares, folders and the like), furniture, picture frames and much more.

Unlike a material such as acrylic glass, compound or composite materials are those obtained by combining different materials and whose chemical and physical properties exceed those of the individual components.

They are used e.g. in the construction trade, in engineering (in vehicle construction, in the aerospace industry, in electrical engineering and electronics, in mechanical engineering and tool manufacture, etc.) and in medicine.

Like acrylic glass, such composite materials can also be based on acrylate.

Many corresponding polymer compositions provided with fillers are known for floor tiles, panels for cosmetic items in bathrooms as well as dishes and other construction purposes.

For example, U.S. Pat. No. 3,847,865 describes products made of simulated marble, U.S. Pat. Nos. 3,324,074 and 3,663,493 describe acrylic polymers with inorganic filler material particles suitable for the production of mouldings and castings, such as table tops, and U.S. Pat. No. 4,085,246 describes simulated granites and their production.

Commercial acrylate-based products are for example the Corian® filled with aluminium trihydroxide (ATH) from E.I. du Pont de Nemours and Company, the ATH-filled Cristalan® from Schock & Co. GmbH, and also their quartz-containing Cristalite®.

In the German patent application 10 2005 004 639.8 of Ashland-Südchemie-Kernfest GmbH, radically curable synthetic resins consisting of poly(meth)acrylate-urethane acrylates in urethane acrylates and optionally reactive diluents and/or (meth)acrylates, their production starting from solutions of multifunctional poly(meth)acrylates and their use as binding agents in radically curable mixtures of materials, as well as the composite materials and workpieces obtained from these mixtures, and also the production and use of these same mixtures of materials, composite materials and workpieces are mentioned for the first time.

According to the patent application, these mixtures of materials must be heated under pressure in the presence of one or more radical chain initiators in order to produce a composite material or workpiece, for example after feeding a mould with superheated steam for preferably 20 to 30 min. at a pressure of preferably 3 to 4 bar to preferably 70 to 130° C.

After hardening has taken place, the composite material or the corresponding workpiece can then be removed from the mould and processed further.

The composite materials or workpieces thus obtained by hot curing stand out positively from the state of the art with regard to their application-related properties.

The use of a pre-cross-linked system which in addition further cross-links in three dimensions results inter alia in a smaller shrinkage and a smaller emission of monomer material such as for example methyl methacrylate (MMA).

This is due to the elimination or at least the reduction of the number and size of cracks and voids in the first case, and of bubbles and pores in the second. The process of cold-curing is not discussed in this patent.

In US Re. 35,280 of Imperial Chemical Industries PLC, on the other hand, the cold curing of unsaturated urethane monomer solutions which are chemically related to the synthetic resins mentioned in the German patent application 10 2005 004 639.8 is described.

However, colourless and light-fast products cannot be formed via the cold curing described there. Firstly, the solutions described there are themselves already brown in colour. Secondly, a combination of benzoyl peroxide and N,N-dimethyl-p-toluidine is used to catalyze the radical polymerization.

Such a curing system, i.e. benzoyl peroxide in combination with an aromatic amine accelerator, is recommended as standard by famous peroxide manufacturers, such as Pergan GmbH or Akzo Nobel Polymer Chemicals BV, for the cold curing of acrylic resins and basically means a rapid curing at room temperature which is barely influenced by moisture and fillers, but also in most cases a yellowing and poor light fastness of the cured end-product. The poor light fastness becomes noticeable in the form of an additional yellowing.

The outcome is different when tert-butyl peroxy maleic acid is used, which is also recommended by famous peroxide manufacturers for the cold curing of acrylic resins.

A rapid curing at room temperature is also achieved in the presence of a suitable combination of a mercaptan and an aqueous, alkaline solution, wherein the end-product is characterized not only by a comparatively small residual monomer content, but also by displaying no yellowing and deficient light fastness.

The only disadvantage is that clouding is observed in the end-product, resulting from the use of the aqueous, alkaline solution.

However, the literature does not describe an example of the cold curing of acrylate-based, filler-free mixtures or of acrylate-based mixtures of materials which are at least free of basic fillers, by means of tert-butyl peroxy maleic acid.

If the cold curing of mixtures of materials by means of tert-butyl peroxy maleic acid for the purpose of producing a composite material or workpiece is described, basic fillers such as aluminium trihydroxide (ATH) or calcium carbonate are necessarily used.

Thus also in WO 02/068519 A2 of E.I. du Pont de Nemours and Company, where basic microspheres (3M™ Zeeospheres™ White Microspheres W-410) are used.

When cold curing mixtures of materials based on acrylate resin and said ceramic microspheres a mixture of demineralized water, a calcium hydroxide dispersion and glycol dimercaptoacetate (GDMA) is used there as an accelerator combination which serves to activate the radical chain reaction (on this subject, see also the unexamined patent application DE 20 06 197 from E.I. du Pont de Nemours and Company), obtaining composite materials together with tert-butyl peroxy maleic acid.

The mixture of materials activated with this accelerator combination reaches maximum temperatures in the range of approximately 130 to 160° C. within minutes, starting from 28° C.

When hot curing such mixtures of materials as also described in WO 02/068519 A2, t-butyl peroxy neodecanoate and 2,2′-azodi(2-methylbutyronitrile) are used as radical chain initiators.

The activation takes place by heating to 80° C. The mixture of materials again reaches maximum temperatures in the range of approximately 100° C. to 160° C. within minutes (after heating here). However, unlike in cold curing, with this method post-curing at 120° C. is once again necessary.

In principle, cold curing is to be preferred to hot curing, as it saves energy and time, and thus ultimately saves costs as well. It saves energy as no supply whatever of heat is necessary. This not only conserves natural resources, but also saves costs. But not only because no costs arise for the energy itself. Since a supply of heat is superfluous, there is no need to operate under pressure, which is necessary with hot curing in order to avoid emissions and counter an uneven shrinkage.

However, if both the supply of heat and pressure are dispensed with, the use of expensive tools and moulds is no longer necessary, which also saves costs.

Cold curing saves time as the necessary tools and moulds are easier and quicker to handle and no post-tempering is necessary either.

In addition, should recourse to a larger number of tools and moulds which are to be used in parallel be necessary, it must be taken into account that these are clearly cheaper, which in turn has a time-saving effect.

The saving of time then in turn allows costs to be saved, as already noted above.

Moreover, organic synthetic glasses/plastics, synthetic glass/plastic workpieces and composite materials and workpieces produced by cold curing are generally completely free of voids and cracks.

In the case of cold curing, there is no temperature gradient, causing an uneven shrinkage (resulting in voids and cracks), in the radically polymerizing mixture, such as in the case of hot curing, where energy in the form of heat is introduced from the outside into the mixture to be radically polymerized via the walls of the receptacle in question.

Also, the organic synthetic glasses/plastics, synthetic glass/plastic workpieces and composite materials and workpieces produced by cold curing are usually completely free of bubbles and pores.

If bubbles and pores still occur in individual cases, the number and size of these is greatly reduced relative to their number and size in materials and workpieces produced by hot curing.

This is explained by the fact that a monomer involving fewer bubbles and pores, such as for example MMA, is released.

Due to a more favourable temperature profile and the more uniform distribution of the reaction heat in the radically polymerizing material in the case of cold curing, the monomer already starts to polymerize evenly while cold, with the result that it is already present for the most part as an oligomer at high temperatures when it can no longer escape the system.

Finally, in the case of cold curing, a resultant significant reduction in emissions compared with the corresponding hot curing is of course also observed.

Just like the conservation, already mentioned above, of natural resources in the form of energy, this reduction in emissions also benefits the environment; in addition, it significantly reduces a potential health risk for the respective people concerned.

### SUMMARY OF THE INVENTION

A cold-curing process for the production of organic synthetic glasses/plastics and also organic synthetic glass/plastic workpieces starting from filler-free acrylate-based mixtures is to be developed, as well as a process for preparing composite materials and workpieces starting from filler-containing acrylate-based mixtures of materials, without the corresponding fillers necessarily having to be of a basic nature.

The organic synthetic glasses/plastics, synthetic glass/plastic workpieces and composite materials and workpieces produced in this way are to stand out positively from the state of the art by having a high light fastness and transparency but no yellowing.

Otherwise they are at least to correspond to the state of the art, be completely free of voids and cracks because of uniform shrinkage and have a smaller number and size of bubbles and pores, because of a markedly reduced emission of monomers such as MMA.

### DETAILED DESCRIPTION OF THE INVENTION

The object described here is achieved by the subject of the present invention.

Filler-free mixtures which surprisingly can be cold cured, obtaining organic synthetic glasses/plastics and also organic synthetic glass/plastic workpieces, as well as filler-containing mixtures of materials, obtaining composite materials and workpieces, can be formulated with synthetic resins based on poly(meth)acrylate-urethane(meth)acrylates in urethane(meth)acrylates and optionally (meth)acrylates and/or reactive diluents, which as pre-cross-linked systems involve a smaller shrinkage and a lower emission of monomers such as methyl methacrylate, and suitable fillers, without the fillers contained in the mixtures of materials necessarily having to be of a basic nature, wherein the synthetic glasses/plastics, synthetic glass/plastic workpieces, composite materials and workpieces obtained in this way are characterized in that they have a high light fastness and transparency, but no yellowing.

Furthermore they are free of voids and cracks, and usually free of bubbles and pores, or the number and size of them is at least markedly reduced compared with the corresponding state of the art.

The process is characterized in that it saves energy and time, and thus ultimately also saves costs.

In order to achieve satisfactory results under cold curing conditions, i.e. a complete and rapid curing of mixtures with synthetic resins based on poly(meth)acrylate-urethane(meth)acrylates in urethane(meth)acrylates and optionally (meth)acrylates and/or reactive diluents, it is not enough to proceed on the basis of the state of the art, for example on the basis of the patent WO 02/068519 A2, in which the catalysis of the radical polymerization using a combination of curing agents from a suitable radical chain initiator (tert-butyl peroxy maleic acid), an accelerator (GDMA), a suitable metal hydroxide (in the form of a calcium hydroxide dispersion) and water is described.

Satisfactory results are to be obtained here even if no basic fillers are contained.

Surprisingly, a rapid and complete curing of the mixtures with synthetic resins based on poly(meth)acrylate-urethane(meth)acrylates in urethane(meth)acrylates and optionally (meth)acrylates and/or reactive diluents is observed only if the radical polymerization catalyzed with a combination of curing agents as described above takes place in the presence of poly(meth)acrylates such as PMMA.

No comparable effect can be achieved by adding monomers such as MMA.

Although, such an acceleration is actually to be expected only when monomeric(meth)acrylates are added, but not when polymers are added.

The acceleration of the cold curing, just like the values for the modulus of elasticity, elongation and bending strength are directly related to the quantity of poly(meth)acrylate.

By adding a suitable quantity of suitable poly(meth)acrylates to the respective mixture, ideally dissolved in a monomer such as methyl methacrylate, all filler-free and—containing mixtures which contain synthetic resins based on poly(meth)acrylate-urethane(meth)acrylates in urethane(meth)acrylates and optionally (meth)acrylates and/or reactive diluents can be cold cured using the combination of curing agents described above.

However, such a combination of curing agents, as e.g. described in WO 02/068519 A2, has the drawback that it normally causes a greater or lesser degree of clouding in the end-product which is attributable to the inorganic salts contained in the alkaline solution.

It would thus be better, with regard to the prevention of a clouding in the end-product, to use the combination of curing agents used in US Re. 35,280 of benzoyl peroxide and aromatic amine.

Clouding is ruled out here, but a degree of yellowing and a deficient light fastness of the end-product is observed when this combination of curing agents is used.

Surprisingly—contrary to the prevailing opinion—suitable combinations of aliphatic peroxides and aliphatic amines are, however, also eminently suitable for the cold curing of filler-free and—containing mixtures of materials which contain synthetic resins based on poly(meth)acrylate-urethane(meth)acrylates in urethane(meth)acrylates and optionally (meth)acrylates and/or reactive diluents.

The synthetic glasses/plastics, synthetic glass/plastic workpieces, composite materials and workpieces obtained in this way are then characterized not only in that they are transparent, i.e. free of clouding, but also in that they display no yellowing and are light fast, due to the use of aliphatic curing agent components.

In principle, the presence of polymeric methyl methacrylate is not necessary in the case of the catalysis by the combination of peroxide and amine.

This combination is moreover characterized in that it consists of only two components and is consequently easier to handle than a system with several components.

All the composite materials and workpieces described in this patent, in addition to the advantages already described, have the same technical advantages vis-à-vis the state of the art as do already those which are hot-cured, as described in the German patent application 10 2005 004 639.8.

Thus a greater resistance to chemicals and temperature stability, and also better optical properties (gloss, colour depth, clarity) are observed, all while retaining the positive properties of systems which correspond to the state of the art, such as a high hardness, impact strength, scratch resistance, UV resistance, hydrophobicity and oleophobicity.

The result is comparable for the correspondingly cold-cured organic synthetic glasses/plastics and organic synthetic glass/plastic workpieces.

In addition to the advantages listed above, their properties at least correspond to the state of the art. Thus they have for example a similar thermoplastic behaviour to that of Plexiglas, but the resistance to chemicals is greater. Unlike Plexiglas, they are also resistant to alcohols, esters, ketones and aromatic hydrocarbons.

Consequently, the invention relates to:

1. Radically cold-curable mixtures of materials, consisting of at least one synthetic resin based on poly(meth)acrylate-urethane(meth)acrylates in urethane(meth)acrylates and optionally (meth)acrylates and/or reactive diluents, optionally further (meth)acrylates and/or reactive diluents, and also poly(meth)acrylates and optionally various ingredients, such as are known to a person skilled in the art, selected from pigments (pigment pastes), fillers such as e.g. natural minerals (in most cases coated with epoxy resin, polyurethane resin or adhesion promoters such as silanes or siloxanes), auxiliaries (e.g. highly dispersed silicic acid as anti-settling agent, waxes as release agents or plasticizers for adjusting the modulus of elasticity, etc.), inhibitors (e.g. 4-methoxyphenol or 2,6-di-tert-butyl-4-methylphenol), curing agent components (e.g. radical chain initiators, amine and mercapto accelerators, aqueous, alkaline solutions) and multi-functional cross-linkers, as well as their production by mixing the constituents listed above.

The further (meth)acrylates and/or reactive diluents mentioned above are normally used, relative to the mixture of materials without ingredients, in a proportion of 5 to 80%, preferably 10 to 60% and particularly preferably 20 to 40%, the poly(meth)acrylates normally in a proportion of 1 to 50%, preferably 2 to 40% and particularly preferably 4 to 15%.

The ingredients are used, relative to the whole of the radically cold-curable mixture of materials, in a proportion of normally 0 to 95%, preferably 5 to 90% and particularly preferably 50 to 90% (on this see also the German patent application 10 2005 004 639.8).

2. Curing agent components,

selected from suitable radical chain initiators, suitable accelerators, optionally suitable metal hydroxides and optionally (ideally deionized) water. In principle each of these components can also already be contained as an auxiliary in the radically curable mixtures of materials according to 1., but not in combination with another component.

The only exception is water, which can also already be contained in the mixtures of materials according to 1. in combination with one of the three other components listed.

Relative to the radically curable mixture of materials without ingredients, the following quantities of 100% curing agent components are used:

Usually 0.1 to 5% radical chain initiator, 0 to 0.2% accelerator, 0 to 3% calcium hydroxide and 0 to 2% water, preferably 0.5 to 3% radical chain initiator, 0.01 to 0.05% accelerator, 0 to 1% calcium hydroxide and 0 to 1% water, particularly preferably 1 to 2% radical chain initiator, 0.02 to 0.03% accelerator, 0 to 0.5% calcium hydroxide and 0 to 0.6% water.

3. Composite materials, organic synthetic glasses and plastics,

which can be prepared by mixing radically cold-curable mixtures of materials according to 1. with curing agent components according to 2. followed by the radical polymerization of the synthetic resins contained in these mixtures and based on poly(meth)acrylate-urethane(meth)acrylates in urethane(meth)acrylates and optionally (meth)acrylates and/or reactive diluents and optionally further (meth)acrylates and/or reactive diluents contained therein.

4. Composite workpieces,

such as e.g. pot handles, switches for electrical equipment, seat buckets, windmill sails, decorative surfaces, garden panels, benches, work surfaces, floor tiles, panels for cosmetic items in bathrooms, dishes and wash basins, consisting of the composite materials described under 3., which can be prepared with shaping after the addition of curing agent components according to 2. to mixtures of materials according to 1. with radical polymerization of the synthetic resins based on poly(meth)acrylate-urethane(meth)acrylates in urethane(meth)acrylates and optionally (meth)acrylates and/or reactive diluents and optionally further (meth)acrylates and/or reactive diluents contained therein.

5. Organic synthetic glass and plastic workpieces,

such as e.g. glazing of aircraft, buses and roofs, lightweight magnifying glasses, prisms, lenses and optical fibres, watch-glasses, protective covering for machines, tubes in the drinks industry, sanitary components such as bath tubs, shower trays and wash basins, containers, space lighting, instruments, corrugated panels in the construction trade, transparent sound-proof walls, items of office equipment, drawing requisites (set squares, folders and the like), furniture and picture frames, consisting of the organic synthetic glasses and plastics described under 3. which can be prepared with shaping after adding curing agent components according to 2. to mixtures of materials according to 1. with radical polymerization of the synthetic resins contained therein and based on poly(meth)acrylate-urethane(meth)acrylates in urethane(meth)acrylates and optionally (meth)acrylates and/or reactive diluents and optionally further (meth)acrylates and/or reactive diluents contained therein.

6. A process for the production of organic synthetic glass, plastic and composite workpieces from synthetic glass, plastic or composite material,

which can be obtained from the radical cold curing of mixtures of materials according to 1. using curing agent components according to 2., wherein the process comprises the steps of
(I) preparing a composition which contains at least one synthetic resin based on poly(meth)acrylate-urethane(meth)acrylates in urethane(meth)acrylates and optionally (meth)acrylates and/or reactive diluents, optionally additional (meth)acrylates and/or reactive diluents, and also poly(meth)acrylates and optionally one or more ingredients, such as are known to a person skilled in the art, selected from pigments (pigment pastes), fillers such as e.g. natural minerals (in most cases coated with epoxy resin, polyurethane resin or adhesion promoters such as silanes or siloxanes), auxiliaries (e.g. highly dispersed silicic acid as anti-settling agent, waxes as release agents or plasticizers for adjusting the modulus of elasticity, etc.), inhibitors (e.g. 4-methoxyphenol or 2,6-di-tert-butyl-4-methylphenol), curing agent components (e.g. radical chain initiators, amine and mercapto accelerators, aqueous, alkaline solutions) and multi-functional cross-linkers.
(II) converting the composition according to (I), adding curing agent components (unless these are already contained in the composition according to (I)), selected from suitable radical chain initiators, suitable accelerators, suitable metal hydroxides and optionally (ideally deionized) water in a mould.
(III) optionally machining the synthetic glass or synthetic glass workpiece, plastic or plastic workpiece or composite material or workpiece obtained under (II) for final shaping.

1. Radically Curable Mixtures of Material

can be prepared by mixing at least one synthetic resin based on poly(meth)acrylate-urethane(meth)acrylates in urethane(meth)acrylates and optionally (meth)acrylates and/or reactive diluents, optionally further (meth)acrylates and/or reactive diluents, and also poly(meth)acrylates and optionally various ingredients such as are known to a person skilled in the art, selected from pigments (pigment pastes), fillers such as e.g. natural minerals (in most cases coated with epoxy resin, polyurethane resin or adhesion promoters such as silanes or siloxanes), auxiliaries (e.g. highly dispersed silicic acid as anti-settling agent, waxes as release agents or plasticizers for adjusting the modulus of elasticity, etc.), inhibitors, curing agent components (e.g. radical chain initiators, amine and mercapto-accelerators, aqueous, alkaline solutions) and multi-functional cross-linkers.

These radically curable mixtures of materials can be set to a suitable viscosity if required by adding reactive diluents and/or (meth)acrylates.

1.1. (Meth)Acrylates

The (meth)acrylates used are normally non-functional, but can also be functional.

1.1.1. Non-Functional (Meth)Acrylates

There are used as non-functional (meth)acrylates, for example, methyl(meth)acrylate, ethyl(meth)acrylate, propyl(meth)acrylate, n-butyl(meth)acrylate, i-butyl(meth)acrylate, n-hexyl(meth)acrylate, 2-ethylhexyl(meth)acrylate, isodecyl(meth)acrylate, dodecyl(meth)acrylate, phenoxyethyl(meth)acrylate, cyclohexyl(meth)acrylate, isobornyl(meth)acrylate, benzyl(meth)acrylate, ethylene glycol nonylphenyl ether(meth)acrylate, tripropylene glycol nonylphenyl ether(meth)acrylate, tetrahydrofurfuryl(meth)acrylate, butyl diglycol(meth)acrylate, (meth)acrylic acid addition product of butyl glycidyl ether, (meth)acrylic acid addition product of phenyl glycidyl ether, N-(2-(meth)acryloyloxy-ethyl)ethylene urea, methoxypolyethylene glycol (meth)acrylate, polyethylene glycol dimethacrylate, ethylene glycol di(meth)acrylate, neopentyl glycol di(meth)acrylate, 1,3-butanediol di(meth)acrylate, 1,4-butanediol di(meth)acrylate, 1,6-hexanediol di(meth)acrylate, 1,12-dodecanethiol di(meth)acrylate, stearyl(meth)acrylate, diethylene glycol di(meth)acrylate, triethylene glycol tri(meth)acrylate, tetraethylene glycol dimethacrylate, trimethylolpropane tri(meth)acrylate, dipentolhexa(meth)acrylate, di(meth)acrylate of the addition product of bisphenol A with ethylene oxide, (meth)acrylic acid addition product of bisphenol A diglycidyl ether, diurethane di(meth)acrylate, trimethylolpropane tri(meth)acrylate, polyester(meth)acrylates and/or melamine (meth)acrylate. 1.1.2. Functional (Meth)Acrylates

The acrylic monomers with hydroxyl functionality used in practice are above all hydroxyethyl acrylate (HEA) and hydroxypropyl acrylate (HPA). The corresponding less toxic hydroxy alkyl methacrylates such as 2-hydroxyethyl methacrylate and 2-hydroxypropyl methacrylate can also be used.

Further monoacrylates that can be used are e.g. diethylene glycol mono(meth)acrylate, polyethylene glycol mono(meth)acrylate, polypropylene glycol mono(meth)acrylate and also the equimolar reaction product comprising glycidyl(meth)acrylate and (meth)acrylic acid.

Polyacrylates such as trimethylol diacrylate (TMDA), trimethylolpropane di(meth)acrylate or glycerol di(meth)acrylate or hydroxyl-functional triacrylates, for example pentaerythritol triacrylate (PETA) also come into consideration.

In principle, of course, (meth)acrylate monomers which have no hydroxyl group but instead have another nucleophilic group also come into consideration, such as e.g. the carboxy, amino or thiol group.

Also in relation to the hydroxyl group multifunctional (meth)acrylates can also be used, thus e.g. dihydroxy functional glycerol mono(meth)acrylate. 1.2. Reactive Diluents

Reactive diluents that can be used are e.g. monofunctional such as isobornyl acrylate or N-vinyl-pyrrolidone, difunctional, such as hexanediol diacrylate (HDDA) or tripropylene glycol diacrylate (TPGDA), and also tri- or tetrafunctional, which cause an increase in the cross-linking density, such as trimethylolpropane triacrylate (TMPTA) or pentaerythritol tetraacrylate (PETA).

The reactive diluents have two important functions. Firstly they reduce the viscosity, and secondly they strongly influence the physical and chemical properties of the respective resulting composite material or of the workpiece.

There are fluid boundaries between the non-functional substituted (meth)acrylates described under 1.1.1. and the reactive diluents described here.

1.3. Poly(Meth)Acrylates

Compounds such as polymethyl methacrylate (PMMA) come into consideration as poly(meth)acrylates; typical commercial representatives are for example the Degalan® ranges from Degussa AG.

1.4. Plasticizers

Phthalic acid esters such as di-2-ethylhexyl phthalate, trimellitic acid esters such as tri-(2-ethylhexyl)-trimellitate, aliphatic dicarboxylic acid esters such as di-2-ethylhexyladipate, polymeric plasticizers such as polyesters from diacids such as adipic acid and diols such as 1,4-butanediol, phosphoric acid esters such as diphenyl cresyl phosphate, fatty acid esters such as triethylene glycol di(2-ethyl butyrate), hydroxycarboxylic acid esters such as citric acid esters, epoxide plasticizers such as epoxidized soya bean oils and polyamide plasticizers such as benzenesulfonamides come into consideration as plasticizers.

Alternatively, plasticizing monomers such as n-butyl(meth)acrylate, i-butyl(meth)acrylate, n-hexyl(meth)acrylate, 2-ethylhexyl(meth)acrylate, isodecyl(meth)acrylate, dodecyl(meth)acrylate or stearyl(meth)acrylate also come into consideration.

1.5. Inhibitors

Suitable stabilizers/inhibitors—for preventing a polymerization and thus increasing the storage stability—are given below by way of example:

1,4-dihydrobenzene(hydroquinone, HQ) 4-methoxy-hydroxy benzene (hydroquinone monomethyl ether, HQME or MEHQ)

2,6-di-tert-butylhydroquinone (DTBHQ)

phenothiazine (thiodiphenylamine, PTZ)

Their proportion is preferably 50-1000 ppm relative to the whole of the mixture of materials.

2. Curing Agent Components

The radical chain initiators and reaction accelerators listed below, and also metal hydroxides and water come into consideration as curing agent components. The concentrations of the curing agent components must be matched.

In principle each of these curing agent components can also already be contained as an auxiliary in the radically curable mixtures of materials according to 1., but not in combination with another component.

The only exception here is water.

2.1. Radical Chain Initiators

Peroxides, in particular ketone peroxides (e.g. methyl ethyl ketone peroxide, acetylacetone peroxide and cyclohexanone peroxide) or diacyl peroxides (e.g. dibenzoyl peroxide and dilauroyl peroxide), acyl peroxides (e.g. tert-butyl monoperoxymaleate), peresters (e.g. di-(4-tert-butylcyclohexyl)-peroxydicarbonate) are suitable as radical chain initiators, but azo compounds (e.g. 2,2′-azodiisobutyronitrile or 2,2′-azodi(2-methylbutyronitrile)) are also conceivable in principle.

A disadvantage of the radical chain initiators with aromatic groups is that they often lead to a yellowing in the end-product, i.e. in the synthetic glass/plastic, synthetic glass/plastic workpiece, composite material or workpiece and reduce its light fastness.

2.2. Accelerators

2.2.1. Amine Accelerators

In particular, aromatic amines such as dimethylaniline, diethylaniline and dimethyl-p-toluidines and aliphatic amines such as for example substituted aminoethanols (2-dibutylaminoethanol, n-butyldiethanolamine, etc.) or substituted aminosilanes (N-cyclohexyl-3-aminopropyltrimethoxysilane, 3-aminopropyltrimethoxysilane, N-cyclohexylaminomethylmethyldiethoxysilane, etc.), in each case pure or in plasticizers, come into consideration as amine accelerators.

All amines are suitable in particular for example in combination with dibenzoyl peroxide, di-(4-tert-butyl-cyclohexyl)peroxydicarbonate, dilauroyl peroxide and dimyristyl peroxydicarbonate.

A disadvantage of the aromatic amines is that they often lead to a yellowing in the end-product, i.e. in the synthetic glass/plastic, synthetic glass/plastic workpiece, composite material or workpiece and reduce its light fastness.

On the other hand, aliphatic amines do not lead to a yellowing and do not reduce light fastness; they are therefore preferably to be used with aliphatic radical chain initiators which also cause no yellowing and no reduction in light fastness.

2.2.2. Mercapto Accelerators

Mercapto accelerators coming into consideration are for example isooctyl mercaptoacetate, glycol dimercaptoacetate or also zinc thioglycolate.

These are exceptionally suitable in particular in combination with tert-butyl peroxymaleic acid.

Mercapto accelerators do not lead to a yellowing and also do not reduce light fastness; however, if too much of such a thio compound is used, it acts as a chain breaker.

2.3. Metal Hydroxides and Water

In particular hydroxides of alkali metals and alkaline-earth metals such as calcium hydroxide come into consideration as metal hydroxides.

The metal hydroxides are used—if at all—only in combination with one or more of the other accelerators.

They can be activated by adding small quantities of (ideally deionized) water.

The water can be already contained in the mixture of materials according to 1. and/or can be added subsequently on its own or together with one or more accelerator(s).

3. Materials and Workpieces

To produce a material or a workpiece, a radically curable mixture of materials according to 1. is mixed with curing agent components according to 2. and placed in a mould.

Alternatively the curing agent components can also be partly or wholly added afterwards to the mixture of materials according to 1, already present in the mould.

Before the mixture of materials according to 1. is placed in the mould, it would then be contained therein only in part if at all.

The procedure depends inter alia on the rate of the radical polymerization which is initiated at room temperature by the combination of reaction initiator(s) and accelerators.

Typical reaction times which can be set by varying the type and quantity of curing agent components lie in the range of 3 to 20 minutes.

Advantageously, the mixtures of materials according to 1. according to the invention are characterized—due to good wetting of the fillers—by very good flow properties, with the result that the mould can be charged more rapidly than in the case of comparable mixtures of materials based on MMA/PMMA corresponding to the status quo.

The mixture of materials according to 1. can thus still be mixed with curing agent components according to 2. even with relatively short reaction times before the mould is charged.

After hardening has taken place, the material or the corresponding workpiece based thereon can be removed from the mould and processed further if required.

### Examples

1. Production by Cold Curing of Synthetic Glass Workpieces, Based on Synthetic Resin, in the Form of Paperweights

1.1. Production or Preparation of Radically Curable Resin Preparations

1.1.1. Preparation of a Synthetic Resin Based on Poly(Meth)Acrylate-Urethane(Meth)Acrylates in Urethane(Meth)Acrylates and Optionally (Meth)Acrylates and/or Reactive Diluents.

Askocryl® 2331/30 from Ashland-Südchemie-Kernfest GmbH is used as synthetic resin.

With a solids concentration of approximately 70% (Sartorius Moisture Analyzer, 2 g, 135° C., 15 min.) it has a Hoppler viscosity according to DIN 53015 of approximately 2,500 mPa·s at 25° C. and contains approximately 70% of a mixture of reactive polymer and urethane methacrylate, and also approximately 30% methyl methacrylate.

The synthesis is based on that described in the German patent application 10 2005 004 639.8 under example A.

1.1.2. Production of a Syrup

80 kg methyl(meth)acrylate is introduced first. Air is passed through the methyl methacrylate. The methyl methacrylate is heated to 50° C. accompanied by stirring and supply of air. 20 kg of an acrylic copolymer based on PMMA (contained monomer building blocks: methyl methacrylate and ethyl acrylate) with an average particle size of 600 μm according to the sieve test, a density according to ISO 1183 of 1.18 g/cm³ and a Vicat softening point of 118° C. according to ISO 306 A or of 109° C. according to ISO 306 B is dissolved in 50° C. hot methyl methacrylate and added thereto portionwise accompanied by stirring.

The syrup obtained in this way, i.e. the solution of 20 kg acrylic copolymer in 80 kg methyl methacrylate is cooled to room temperature and the air supply is then stopped.

At 20° C. a viscosity of approximately 280 mPa·s is measured according to ISO 2555 on the Brookfield viscometer.

1.1.3. Production of a Radically Curable Mixture of Material

55.28 kg synthetic resin according to 1.1. and 40.2 kg syrup according to 1.2. are mixed together. At 20° C. a viscosity of approximately 475 mPa·s is measured according to ISO 2555 on the Brookfield viscometer.

1.2. Manufacture of Workpieces

1.2.1. Manufacture Using the Synthetic Resin According to 1.1.1. (with the Curing Agent Combination Peroxide, Mercaptan and Alkaline Solution, without PMMA)

8.2 g tert-butyl permaleate (25% paste preparation in a plasticizer), 1.0 g calcium hydroxide, 1.3 g water and 0.4 g of a 10% solution of isooctyl mercaptoacetate in ethylene glycol are added at room temperature and accompanied by stirring successively to 204.5 g of the synthetic resin according to 1.1.1.

The mixture is homogenized and ventilated by stirring it in a vacuum for two minutes and then poured into a shallow, rectangular mould (11.5 cm×8.5 cm×2.0 cm), where the cold curing takes place. A maximum temperature of just 110° C. is observed, and that only after 15 min.

The colourless, rectangular workpiece in the form of a paperweight is characterized in that it is light fast (no visually perceptible yellowing after exposure for 240 h according to ISO 2809 in the QUV Accelerated Weathering Tester from Q-Lab Corporation) and completely free of bubbles, voids, pores and cracks.

Owing to the poor hardening, the mechanical properties, measured on a Zwick material testing machine 1425 using testpieces measuring 6 mm×10 mm×100 mm, are very modest.

Thus it has a modulus of elasticity according to ISO 527 of only 1993 MPa, a small elongation according to ISO 37 of 0.65% and a small bending strength according to ISO 178 of 36 N.

In addition, the workpiece is not transparent, but cloudy.

1.2.2. Manufacture Using the Radically Curable Mixture of Materials According to 1.1.3. (with the Curing Agent Combination Peroxide, Mercaptan and Alkaline Solution, with PMMA)

8.2 g tert-butyl permaleate (25% paste preparation in a plasticizer), 1.0 g calcium hydroxide, 1.3 g water and 0.4 g of a 10% solution of isooctyl mercaptoacetate in ethanediol are added at room temperature and accompanied by stirring successively to 203.2 g of the radically curable mixture of materials according to 1.1.3.

The mixture is homogenized and ventilated by stirring it in a vacuum for two minutes and then poured into a shallow, rectangular mould (11.5 cm×8.5 cm×2.0 cm), where the cold curing takes place.

A maximum temperature of 130° C. is observed after only 9 minutes.

The colourless, rectangular workpiece in the form of a paperweight is characterized in that it is light fast (no visually perceptible yellowing after exposure for 240 h according to ISO 2809 in the QUV Accelerated Weathering Tester from Q-Lab Corporation) and completely free of bubbles, voids, pores and cracks.

In addition, it has good mechanical properties, measured on a Zwick material testing machine 1425 using testpieces measuring 6 mm×10 mm×100 mm, i.e. a modulus of elasticity according to ISO 527 of 2427 MPa, an elongation according to ISO 37 of 2.6% and a bending strength according to ISO 178 of 150 N.

In addition it has a high chemical stability, as can be seen from the table below, in particular vis-à-vis non-halogenated organic solvents (aliphatics, aromatics, esters, etc.), water, dilute acids (formic acid [10%], hydrochloric acid [5%], nitric acid [10%], phosphoric acid [10%], sulphuric acid [10%], etc.) and alkalis (caustic soda solution, etc.).

| Reduction in | |
|---|---|
| weight | Chemicals |
| <0.1% | Solvesso 100, toluene, butyl acetate, n-butanol |
| <0.2% | Dilute acids: HCOOH [10%], HCl [5%], HNO₃ [10%], |
| | H₃PO₄ [10%], H₂SO₄ [10%] |
| | Conc. acids: fuming hydrochloric acid, phosphoric |
| | acid [85%] |
| | Water, caustic soda solution [30%] |
| <0.5% | Ethanol |
| <5.0% | Acetone, oil of vitriol |
| <10% | Formic acid |
| <15% | Fuming nitric acid |
| 100% | Chloroform, dichloromethane |

HCOOH = formic acid, HCl = hydrochloric acid, HNO₃ = nitric acid, H₃PO₄ = phosphoric acid, [%] = concentration of the solution

In the table, the weight loss of testpieces measuring 75 mm×16 mm×10 mm after 24 h of storage in selected chemicals serves as a measure of chemical stability.

Moreover, the workpiece behaves like a thermoplastic when heat is added.

An 11 mm-thick testpiece made of this synthetic glass can be bent with difficulty at 100° C., easily at 120° C. Any deformation remains after cooling.

A disadvantage is that the workpiece—as also under 1.2.1.—is not transparent, but cloudy.

1.2.3. Manufacture Using the Synthetic Resin According to 1.1.3. (with Aromatic Radical Chain Initiator and Aromatic Amine, with PMMA)

0.82 g comminuted N,N-di(2-hydroxyethyl)-p-toluidine is added at room temperature and accompanied by stirring to 102.25 g of the radically curable mixture of materials according to 1.1.3 and kept, accompanied by stirring, for two hours, until everything has dissolved, obtaining component A.

Likewise, 3.07 g 75% dibenzoyl peroxide (desensitized in water) is added to 102.25 g of the radically curable mixture of materials according to 1.1.3. and this mixture is stirred for 10 min., with the result that it is homogeneous, obtaining component B. Component A and component B are then mixed together.

In order to make the mixture homogeneous again and vent it, it is stirred in a vacuum for two minutes and then poured into a shallow, rectangular mould (11.5 cm×8.5 cm×2.0 cm), where the cold curing takes place.

A maximum temperature of 160° C. is observed after only 9 min.

The transparent, rectangular workpiece in the form of a paperweight is characterized in that it is completely free of bubbles, voids, pores and cracks.

In addition, it has good mechanical properties, measured on a Zwick material testing machine 1425 using testpieces measuring 5.3 mm×10 mm×100 mm, i.e. a modulus of elasticity according to ISO 527 of 2485 MPa, an elongation according to ISO 37 of 1.45% and a bending strength according to ISO 178 of 68 N, as well as high chemical stability, in particular vis-à-vis non-halogenated organic solvents (aliphatics, aromatics, esters, etc.), water, dilute acids (formic acid [10%], hydrochloric acid [5%], nitric acid [10%], phosphoric acid [10%], sulphuric acid [10%], etc.) and alkalis (caustic soda solution, etc.).

The workpiece behaves like a thermoplastic when heat is added.

An 11 mm-thick testpiece made of this synthetic glass can be bent with difficulty at 100° C., easily at 120° C. Any deformation remains after cooling.

A disadvantage is that the workpiece displays a marked yellowing and in addition is not light-resistant (visually perceptible yellowing after exposure for 240 h according to ISO 2809 in the QUV Accelerated Weathering Tester from Q-Lab Corporation).

The PMMA obtained causes a slight clouding.

1.2.4. Manufacture Using the Synthetic Resin According to 1.1.1. (with Aliphatic Radical Chain Initiator and Amine, without Polymethyl Methacrylate)

3.48 g 95% di-(4-tert-butylcyclohexyl)peroxydicarbonate in powder form is added at room temperature and accompanied by stirring to 102.25 g of the synthetic resin according to 1.1.1. and the mixture is stirred for one hour, until everything has dissolved, obtaining component A.

Likewise, 1.03 g 2-dibutylaminoethanol is added to 102.25 g of the synthetic resin according to 1.1.1. and this mixture is stirred for 10 min., with the result that it is homogeneous, obtaining component B. Component A and component B are then mixed together.

In order to make the mixture homogeneous again and vent it, it is stirred in a vacuum for two minutes and then poured into a shallow, rectangular mould (11.5 cm×8.5 cm×2.0 cm), where the cold curing takes place.

A maximum temperature of 124° C. is observed after only 12 min.

The transparent, glass-clear and also colourless, rectangular workpiece in the form of a paperweight is characterized in that it is light-resistant (no visually perceptible yellowing after exposure for 240 h according to ISO 2809 in the QUV Accelerated Weathering Tester from Q-Lab Corporation), and also completely free of bubbles, voids, pores and cracks.

In addition, it has good mechanical properties, measured on a Zwick material testing machine 1425 using testpieces measuring 6 mm×10 mm×150 mm, i.e. a modulus of elasticity according to ISO 527 of 2790 MPa, an elongation according to ISO 37 of 0.78% and a bending strength according to ISO 178 of 54 N, as well as high chemical stability, in particular vis-à-vis non-halogenated organic solvents (aliphatics, aromatics, esters, etc.), water, dilute acids (formic acid [10%], hydrochloric acid [5%], nitric acid [10%9 , phosphoric acid [10%], sulphuric acid [10%], etc.) and alkalis (caustic soda solution, etc.).

The workpiece behaves like a thermoplastic when heat is added.

An 11 mm-thick testpiece made of this synthetic glass can be bent with difficulty at 100° C., easily at 120° C. Any deformation remains after cooling.

1.3. Summary of the Characteristic Data of the Workpieces Described Under 1.2.

| Workpiece according to | | | |
|---|---|---|---|
| 1.2.1 | 1.2.2. | 1.2.3. | 1.2.4. |

Composition of the cured mixtures

| | | | | |
|---|---|---|---|---|
| Combination of | PM Ca(OH)₂IOMA | PM Ca(OH)₂IOMA | BP DHET | BCHP DBAE |
| curing agents | | | | |
| Contains PMMA? | no | yes | yes | no |

Visual impression

| | | | | |
|---|---|---|---|---|
| No yellowing? | yes | yes | no | yes |
| Light fast? * | yes | yes | no | yes |
| Transparent? | no | no | yes ** | yes |

Physical characteristic data

| | | | | |
|---|---|---|---|---|
| Modulus of | 1993 | 2427 | 2485 | 2790 |
| elasticity [MPa] | | | | |
| Elongation [%] | 0.65 | 2.6 | 1.45 | 0.78 |
| Bending | 36 | 150 | 68 | 54 |
| strength [N] | | | | |

PM Ca(OH)₂IOMA = tert-butylpermaleate, calcium hydroxide, water and isooctyl mercaptoacetate
BP = dibenzoyl peroxide, N,N-di(2-hydroxyethyl)-p-toluidine
BCHP = di(4-tert-butylcyclohexyl)peroxydicarbonate and 2-dibutylaminoethanol
PMMA = polymethyl methacrylate
* = no visually perceptible yellowing after exposure for 240 h according to ISO 2809 in the QUV Accelerated Weathering Tester from Q-Lab Corporation
** = slight clouding caused by the contained PMMA
Modulus of elasticity according to ISO 527, elongation according to ISO 37, bending strength according to ISO 178

2. Production by Cold Curing of a Composite Resin- and Quartz-Based Workpiece in the Form of a Sink

2.1. Production of a Radically Curable, Filled Mixture of Material

55.28 kg synthetic resin according to 1.1.1. and 40.20 kg syrup according to 1.1.2. are mixed together.

95.48 kg cristobalite powder SF 3000 from Quarzwerke GmbH (average particle size: 7 μm, top particle size: 24 μm) and 0.5 kg titanium dioxide paste (50% in radically curable mixture of materials according to 1.3.) are added to this and the whole is mixed again.

At 20° C. a viscosity of approximately 1.4 Pa·s. is measured on an NT viscometer from Schleibinger Geräte Teubert und Greim GmbH on the basis of EN ISO 3219 or DIN 53019 using a glue paddle.

2.2. Manufacture of a Workpiece

0.48 kg comminuted N,N-di(2-hydroxyethyl)-p-toluidine is added at room temperature and accompanied by stirring to 47.74 kg of the radically curable mixture of materials according to 2.1. and the mixture is stirred for two hours, obtaining component A. Likewise, 1.91 kg 75% dibenzoyl peroxide (desensitized in water) is added to 47.74 kg of the radically curable mixture of materials and this mixture is stirred for 10 min., with the result that it is homogeneous, obtaining component B. Component A and component B are then mixed together. The mixture is homogenized and vented by stirring it in a vacuum for five minutes. A sink mould is then immediately charged within 70 seconds. The cold curing takes place in the mould. After ten minutes the finished sink can be removed from the mould.

Just like a hot-cured Askocryl®-based sink according to DE 10 2005 004 639.8, it is characterized by a high shine, a high brilliance, a depth of colour, a smooth surface, the absence of cracks and good mechanical properties, measured on a Zwick material testing machine 1425 using testpieces measuring 6 mm×10 mm×100 mm, i.e. a modulus of elasticity according to ISO 527 of 7830 MPa, an elongation according to ISO 37 of 0.46% and a bending strength according to ISO 178 of 90 N, as well as high chemical stability, i.e. e.g. after 500 cycles in the hot/cold water alternation test (15° C./90° C.) no cracks or lightening of the colour whatever is observed. In addition, there are no bubbles, voids, pores and cracks whatever.

1. Radically curable composition, based on poly(meth)acrylate-urethane(meth)acrylates in urethane(meth)acrylate, obtainable by:
a) preparing (meth)acrylate monomers,
b) polymerizing the (meth)acrylate monomers to a poly(meth)acrylate,
c) reacting the poly(meth)acrylate, and with an isocyanate compound which has more than one isocyanate group,
d) reacting the composition contained in c) with (meth)acrylate monomers,
e) initiating a radical polymerization in the presence of a suitable quantity of poly(meth)acrylate.

2. Radically curable composition according to claim 1, characterized in that a curing agent is further added which comprises a peroxide, a thiol and an alkaline solution.

3. Radically curable composition according to claim 2, characterized in that peroxide tertbutylpermaleate is used as peroxide.

4. Radically curable composition, based on poly(meth)acrylate-urethane(meth)acrylate in urethane(meth)acrylate, obtainable by:
a) providing (meth)acrylate monomers,
b) polymerizing the (meth)acrylate monomers to a poly(meth)acrylate,
c) reacting the poly(meth)acrylate, and with an isocyanate compound which has more than one isocyanate group,
d) reacting the composition obtained in c) with (meth)acrylate monomers,
characterized in that a mixture of an aliphatic peroxide and an aliphatic amine is used as curing agent.

5. Radically curable composition according to claim 4, characterized in that di-4(tertbutylcyclohexyl)peroxide carbonate is used as aliphatic peroxide.

6. Radically curable composition according to claim 5, characterized in that 2-dibutylaminoethanol is used as aliphatic amine.

7. Radically curable composition according claim 1, characterized in that it is cured by radical polymerization at temperatures of less than 40° C.

8. Radically curable composition according to claim 7 which additionally comprises a multifunctional cross-linker.

9. Use of a radically curable composition according claim 1 for the production of a composite material, composite workpiece or lacquer.

10. Composite material or composite workpiece comprising a radically curable composition according claim 1 in cured form.

11. Process for the production of a composite material or composite workpiece according to claim 10, wherein the curing takes place without the application of warmth or heat of more than 40° C.
